(19) United States
(12) Patent Application Publication
(10) Pub. No.: US 2025/0297964 A1
(43) Pub. Date: Sep. 25, 2025

(54) Determination of Inhomogeneities During Electrode Manufacturing for Battery Cells

(71) Applicant: Siemens Aktiengesellschaft, München (DE)

(72) Inventors: Alexander Michael Gigler, Untermeitingen (DE); Sascha Schulte, Höchstadt (DE); Roland Pohle, Herdweg (DE); Clemens Otte, München (DE); Jonas Witt, Nürnberg (DE); Susanne Kornely, Puchheim (DE); Manfred Baldauf, Erlangen (DE)

(73) Assignee: Siemens Aktiengesellschaft, München (DE)

(21) Appl. No.: 18/862,331

(22) PCT Filed: Apr. 21, 2023
(86) PCT No.: PCT/EP2023/060397

§ 371 Date: Nov. 1, 2024

(30) Foreign Application Priority Data
May 6, 2022 (EP) 22172002.2

(51) Int. Cl. G01N 21/89; G01N 15/0205; G01N 21/31; G06T 7/00; H01M 4/04

(52) U.S. Cl. CPC G01N 21/8901; G01N 15/0205; G01N 21/31; G06T 7/0004; H01M 4/04; G06T 2207/10048; G06T 2207/20081; G06T 2207/30108

(57) ABSTRACT

Various embodiments of the teachings herein include an apparatus for hyperspectral imaging of electrode webs during electrode manufacturing for battery cells. An example includes: a hyperspectral spectroscopy unit with a line scan camera for imaging, the spectroscopy unit configured: to capture hyperspectral images of the forward-moving electrode web at a predefined location of the electrode manufacturing, to ascertain inhomogeneities of the electrode web from the images, wherein an inhomogeneity is a deviation of the chemical composition of the layers or of the particle size distribution from predefined target variables, and to ascertain and save a local position of the inhomogeneities in the longitudinal direction of the electrode web; and a deflection roll over which the electrode web is guided. The line scan camera captures the images at the position of the contact surface between the deflection roll and the electrode web.

### CROSS-REFERENCE TO RELATED APPLICATIONS

This application is a U.S. National Stage Application of International Application No. PCT/EP2023/060397 filed Apr. 21, 2023, which designates the United States of America, and claims priority to EP application Ser. No. 22/172,002.2 filed May 6, 2022, the contents of which are hereby incorporated by reference in their entirety.

### TECHNICAL FIELD

The present disclosure relates to batteries. Various embodiments of the teachings herein include apparatus and/or methods for hyperspectral imaging of electrode webs during electrode manufacturing for battery cells.

### BACKGROUND

Lithium-ion rechargeable batteries, also called lithium-ion batteries hereinafter, are used as energy stores in mobile and stationary applications on account of their high power density and energy density. A lithium-ion battery typically comprises a plurality of battery cells. A battery cell, in particular a lithium-ion battery cell, comprises a multiplicity of layers. These layers typically comprise anodes, cathodes, separators and further elements. These layers may be configured as stacks or as windings.

The electrodes usually comprise metal foils, in particular comprising copper and/or aluminum, which are coated with an active material. In this case, a lithium-containing paste, called slurry, is typically applied as active material. The foils and the coating each have a thickness of a few micrometers. As a result, a few micrometers deviation in the thickness of the coating or in the material property, in particular the material composition, already have adverse effects on the quality of the electrode. It is disadvantageous that in the case of irregular coating, low-quality battery cells are thus produced. It is furthermore disadvantageous that reliable operation of the battery cell is not ensured.

Defective coatings often cannot be demonstrated until after the conclusion of the entire battery cell production process in the context of a so-called end-of-line test. In some instances, defective coatings are not actually established until after several years of battery cell operation.

Battery materials for battery cell manufacturing are deposited or applied onto the electrode web as a viscous medium (a coating paste, referred to as: slurry) during production. The continuous determination of material parameters (e.g. composition, homogeneity of the distribution of an ingredient, moisture . . . ) along an (infinite-length) manufacturing section/product web (e.g. battery electrodes, paper web, steel, . . . ) or a series manufacturing installation (e.g. cookies, pretzels, brake linings, . . . ) is of critical importance for the result.

Especially battery cell manufacturing (here in relation to lithium-ion cells) nowadays is very often characterized by an explorative procedure (i.e. rather a mixture of craft and art instead of science or a completely understood industrial process). In this case, the pasty active material is applied (typically sequentially) on both sides of a long electrode web, and is dried and processed. In this case, primarily process parameters are often stored as cooking recipes (e.g. drying for x hours at y degrees) and are barely monitored by means of sensors.

Since for the pasty mixture, the so-called slurry, composed of NMC or graphite (as main constituents) with a solvent and optionally further components (e.g. carbon black), which is applied to the electrode web, the ingredients are mixed in a mixer and here the homogeneity of the mixture and the viscosity are crucial for the performance of the later battery cell, and thus of the entire later battery, this homogeneity of the coating must necessarily be monitored in the production process.

In the case of a suboptimally homogenized mixture, regions will in this case occur which arise with more or less solvent (water, NMP) during coating. On the other hand, regions of varying chemical composition also arise as a result. Furthermore, a nonuniform deagglomeration of the solid particles may occur, i.e. a deviation of the particle size or particle size distribution from the target value if the mixing process is subject to fluctuations. Closed-loop feedback between the recognition of the inhomogeneity and the slurry mixer is thereby made possible.

During further processing, these regions may then lead to nonuniform behavior of the electrodes produced and/or cause short circuits and inefficiency in the battery cells. In the prior art, as random samples, in an extractive procedure, portions are stamped from the produced web or entire sections are taken from production. The material thus taken is then analyzed by microscopy in the best case. Deviations of the chemical composition of the layers or of the particle size distribution may be detected offline (in laboratory experiments) by way of x-ray methods.

### SUMMARY

Teachings of the present disclosure may improve electrode manufacturing for battery cells. For example, some embodiments include an apparatus for hyperspectral imaging of electrode webs (26, 1) during electrode manufacturing for battery cells, comprising: a) at least one hyperspectral spectroscopy unit (27) comprising a line scan camera (21) for imaging, wherein the spectroscopy unit (27) is arranged and configured to capture hyperspectral images of the forward-moving electrode web (26, 1) at a predefined location of the electrode manufacturing, to ascertain inhomogeneities of the electrode web (26, 1) from the images, wherein an inhomogeneity is a deviation of the chemical composition of the layers or of the particle size distribution from predefined target variables, and to ascertain and save the local position of the inhomogeneities in the longitudinal direction of the electrode web (26, 1), and b) a deflection roll (25), over which the electrode web (26, 1) is guided, wherein the line scan camera (21) captures the images at the position of the contact surface between the deflection roll (25) and the electrode web.

In some embodiments, saving the local position of the inhomogeneity is effected by marking on the electrode web (26, 1).

In some embodiments, there is an engraving unit (28) configured to implement the marking by way of an engraving at the longitudinal edge of the electrode web (26, 1).

In some embodiments, there is a storage unit (23.1) configured to store spectral characteristics of the inhomogeneity as spatial encoding along the electrode web (26, 1) in such a way that the position of the inhomogeneity is able to be found on the basis of the spectral characteristics.

In some embodiments, there is a manufacturing control system (24), to which the spectroscopy unit (27) is connected and which is configured to trigger the spectroscopy unit (27) for measurement.

In some embodiments, there is an evaluation and computing unit (23) at the location of the spectroscopy unit (27), wherein the evaluation and computing unit (23) is configured to compress data of the spectroscopic imaging in a vector and to assign same to the local position.

In some embodiments, the line scan camera (22) is an SWIR line scan camera.

In some embodiments, the spectroscopy unit (27) comprises an AI engine configured to ascertain the inhomogeneities in a computer-aided manner.

In some embodiments, the AI engine is trained to ascertain the inhomogeneities from the spectra by means of deep learning methods.

As another example, some embodiments include a method for ascertaining inhomogeneities by means of hyperspectral imaging of electrode webs (26, 1) during electrode manufacturing for battery cells, characterized by: capturing hyperspectral images of the forward-moving electrode web (26, 1) at a predefined location of the electrode manufacturing, ascertaining inhomogeneities of the electrode web from the spectra of the images, wherein an inhomogeneity is a deviation of the chemical composition of the layers or of the particle size distribution from predefined target variables, and ascertaining and saving the local position of the inhomogeneities in the longitudinal direction of the electrode web (26, 1), wherein the line scan camera captures the images at the position of the contact surface between a deflection roll (25), over which the electrode web is guided, and the electrode web.

In some embodiments, saving the local position of the inhomogeneity is effected by marking on the electrode web.

In some embodiments, the spectral characteristics of the inhomogeneity are saved as spatial encoding along the electrode web in such a way that the position of the inhomogeneity is able to be found on the basis of the spectral characteristics.

In some embodiments, the inhomogeneities are ascertained in a computer-aided manner by means of an AI engine.

### BRIEF DESCRIPTION OF THE DRAWINGS

Further features and advantages of the teachings herein are apparent from the following explanations of an exemplary embodiment with reference to schematic drawings.

In the figures:

FIG. 1 shows coating of a carrier foil incorporating teachings of the present disclosure;

FIG. 2 shows the drying of the coated carrier foil incorporating teachings of the present disclosure;

FIG. 3 shows the calendering of the dried carrier foil incorporating teachings of the present disclosure;

FIG. 4 shows a block diagram of an example hyperspectral measurement arrangement incorporating teachings of the present disclosure; and

FIG. 5 shows an excerpt from a hyperspectral image of an electrode web.

### DETAILED DESCRIPTION

Teachings of the present disclosure may be used in the determination of the local position of inhomogeneities in electrode webs during production of the coated electrodes for battery manufacturing. For example, some embodiments include an apparatus for hyperspectral imaging of electrode webs during electrode manufacturing for battery cells. The apparatus comprises: at least one hyperspectral spectroscopy unit comprising a line scan camera for imaging, wherein the spectroscopy unit is arranged and configured: to capture hyperspectral images of the forward-moving electrode web at a predefined location of the electrode manufacturing, to ascertain inhomogeneities of the electrode web from the images, wherein an inhomogeneity is a deviation of the chemical composition of the layers or of the particle size distribution from predefined target variables, and to ascertain and save the local position thereof (i.e. a spatial encoding) in the longitudinal direction of the electrode web.

The electrode web is a carrier foil coated with the slurry. The line scan camera is referred to in English as “push broom scanner”. “Saving” is broadly defined, including in the sense of “storing” or “marking”. The wavelengths of the hyperspectral imaging are chosen by a person skilled in the art depending on the inhomogeneities to be detected and depending on the substances from which the slurry, i.e. the coating of the electrode web, is formed.

By way of example, the inhomogeneity can be determined by a comparison with previously ascertained reference images (=target variables). Reference images can be obtained for example from an electrode web produced earlier with a demonstrated homogeneous structure or from an averaging of images that originate from the first meters of an electrode web just produced.

The apparatus comprises a deflection roll, over which the electrode web is guided, wherein the line scan camera captures the images at the position of the contact surface between the deflection roll and the electrode web.

In some embodiments, the apparatus is designed to carry out the saving of the local position of the inhomogeneity by marking on the electrode web. For example, the markings may be found again during the cutting of the electrode web and may be used for sorting.

In some embodiments, the apparatus comprises an engraving unit configured to implement the marking by way of an engraving preferably at the longitudinal edge of the electrode web. This can be done by a laser engraving machine, for example.

In some embodiments, the apparatus comprises a storage unit configured to store spectral characteristics of the inhomogeneity as spatial encoding along the electrode web in such a way that the position of the inhomogeneity is able to be found on the basis of the spectral characteristics. The stored spectra of the inhomogeneities may be found again during the cutting of the electrode web, for example.

In some embodiments, the apparatus comprises a manufacturing control system, to which the spectroscopy unit is connected and which is configured to trigger the spectroscopy unit for measurement. This allows a later local assignment of the measurement, for example during the cutting and sorting of electrode webs.

In some embodiments, the apparatus comprises an evaluation and computing unit at the location of the spectroscopy unit, wherein the evaluation and computing unit is configured to precompress data of the spectroscopic imaging in a vector and to assign same to the local position. A measure of the lateral distribution of materials along a considered measurement line is ascertained as a result. In other words, a vector of the inhomogeneity is created.

In some embodiments, the line scan camera is an SWIR line scan camera. A cost-effective solution is thus possible.

In some embodiments, the apparatus comprises in the spectroscopy unit an AI engine configured to ascertain the inhomogeneities in a computer-aided manner.

In some embodiments, the AI engine is trained to ascertain the inhomogeneities from the spectra by means of deep learning methods.

Some embodiments include a method for ascertaining inhomogeneities by means of hyperspectral imaging of electrode webs during electrode manufacturing for battery cells, the method comprising: capturing hyperspectral images of the forward-moving electrode web at a predefined location of the electrode manufacturing, ascertaining inhomogeneities of the electrode web from the spectra of the images, wherein an inhomogeneity is a deviation of the chemical composition of the layers or of the particle size distribution from predefined target variables, and ascertaining and saving the local position of the inhomogeneities in the longitudinal direction of the electrode web.

The line scan camera captures the images at the position of the contact surface between a deflection roll, over which the electrode web is guided, and the electrode web.

In some embodiments, saving the local position of the inhomogeneity is effected by marking on the electrode web.

In some embodiments, the spectral characteristics of the inhomogeneity are saved as spatial encoding along the electrode web in such a way that the position of the inhomogeneity is able to be found on the basis of the spectral characteristics.

In some embodiments, the inhomogeneities are ascertained in a computer-aided manner by means of an AI engine.

The teachings herein may allow, inter alia:
measurement at a deflection roll or over a supporting/stabilizing web segment,
direct online assessment allows closed-loop feedback with e.g. the upstream dryer,
near-field precompression of the data reduces the load on the IT and, by way of the attendant semantic annotation, enables a physically “correct” assessment (in the sense of a real measurement variable instead of “house number”),
creation of the semantic annotation,
integration in manufacturing automation,
assignment to a position along the “product”,
traceability,
continuous measurement information,
nondestructive without sampling, and
a continuous acquisition in the process, yielding a characteristic 2D inhomogeneity indication suitable for identification/recognition of web segments in subsequent process steps.

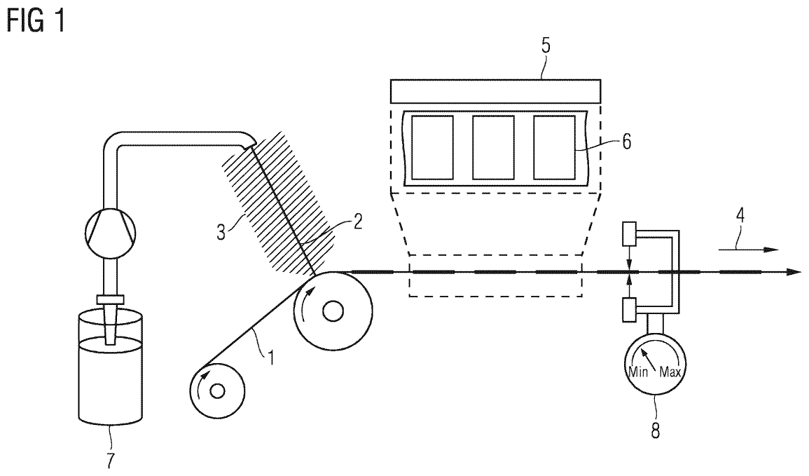

FIG. 1 to FIG. 3 show electrode manufacturing for batteries schematically and by way of example. Firstly, a carrier foil 1 is coated with the slurry 2, which is conveyed from a store 7, by way of an application tool 3, e.g. a slotted nozzle, a doctor blade or an anilox roller (FIG. 1). The carrier foil 1 is coated either continuously or intermittently in the coating direction 4 (intermittent coating 6 in the plan view 5).

The foil thicknesses (anode—copper foil, and cathode-aluminum foil) fluctuate between 10 μm and 25 μm depending on the battery cell design. The carrier foil 1 is coated over a width of up to 900 mm in a roll-to-roll process.

The coating of the foil top side and foil underside is effected either sequentially or simultaneously, depending on the configuration of the manufacturing installation. The thickness of the coating 6 with the slurry 2 is ascertained when still in a moist state by means of a wet thickness measurement 8.

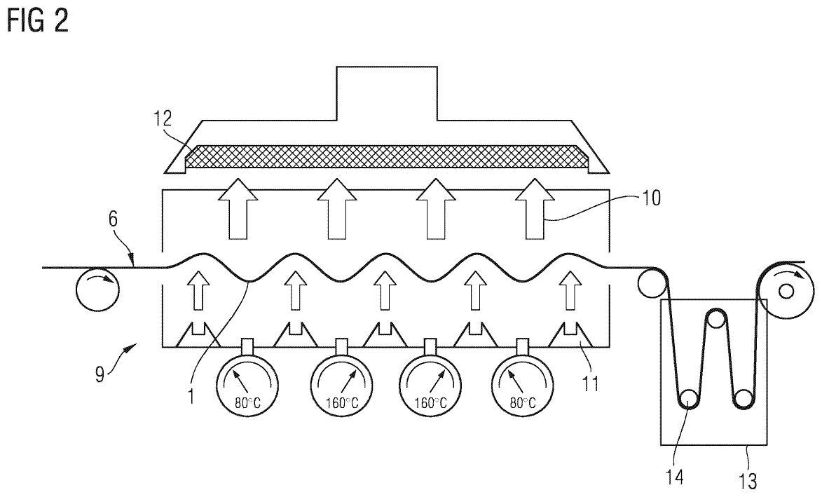

After coating (FIG. 1), the coated carrier foil 1 (also able to be referred to as an electrode web) is guided directly into a dryer 9 (FIG. 2). A floating web dryer is used in the case of a simultaneous, double-sided coating. The solvent (vapors 10 via extractor 12) is extracted from the coating 6 by supply of heat via air nozzles 11 and is recovered again or fed for thermal utilization.

The dryer length is crucial for the throughput speed that can be realized. The dryer 9 is subdivided into different temperature zones in order to implement an individual temperature profile. After passing through the dryer, the dried electrode web (=coated carrier foil 1) is cooled to room temperature by a cooling device 13 with the aid of cooling rollers 14.

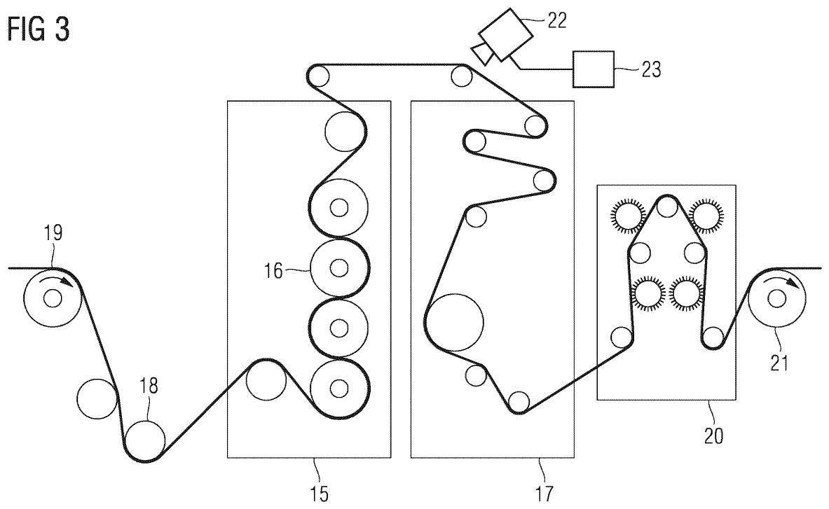

During subsequent calendering 15 (FIG. 3), the carrier foil 1 coated on both sides is compressed by one or more rotating roller pairs 16. The foil is compressed by upper and lower rollers. The roller pair 16 generates an exactly settable linear pressure. The linear pressure determines the porosity of the electrode web. A linear pressure set too high produces a squeezing process and damages the electrode web. The cleanness of the roller pair 16 is crucial for avoiding the penetration of foreign particles into the substrate material.

The carrier foil 1 is transported through the calender 15 with the aid of a traction mechanism 17. The draw-in feed 18 ensures clean introduction from a storage roll 19 into the calender 15. After calendering, the electrode web is cleaned in a cleaning mechanism 20 and stored as “mother coil 21” for further processing to form battery cells, such as cutting, for example.

In some embodiments, a hyperspectral measurement is effected after drying (FIG. 2) or after calendering (FIG. 3) by means of a line scan camera 22 and a downstream evaluation and computing unit 23.

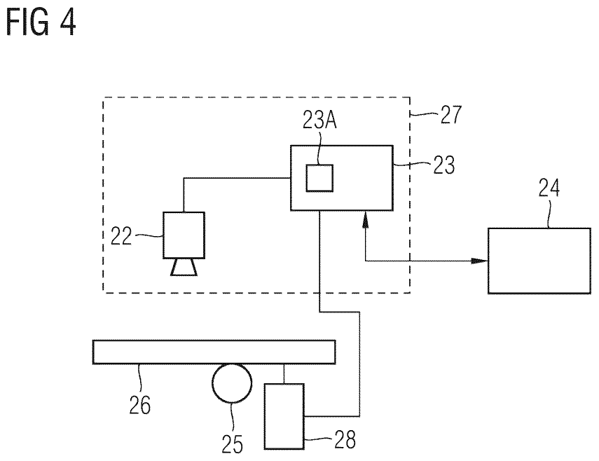

FIG. 4 shows the block diagram of an example hyperspectral measurement arrangement incorporating teachings of the present disclosure. The arrangement comprises a spectroscopy unit 27 with a line scan camera 22, which captures the hyperspectral images of the coated carrier foil (=electrode web 26) at the location of a deflection roll 25. The line scan camera 22 is connected to the evaluation and computing unit 23, which is in turn connected to a manufacturing control system 24 of the electrode web manufacturing. An engraving unit 28 is provided for the purpose of marking the electrode web for 26 example at established inhomogeneities.

As illustrated in FIG. 4, the hyperspectral imaging in the variant of the line scan camera 22 (=push broom scanner: linear measurement of spectra with high lateral i.e. spatial resolution) may be used at the deflection roll 25 in order:
a) to consider a stationary electrode web position,
b) to obtain a synchronization with the relative movement of the electrode web,
c) to enable traceability of the position and
d) to create a stable measurement situation (robust to withstand vibration, able to be darkened, etc.).

In the SWIR (850-1700 nm), the imaging reveals (also inexpensively inter alia) signatures that vary with the degree of homogeneity of the distribution of the starting materials.

In the NIR (1200-2500 nm), even more specific bands are possible but the price of the spectral devices is high. The use of the SWIR is therefore advantageous from economic standpoints.

In this case, the spectral measurement system may be linked to the manufacturing control system 24 (PLC, edge, etc.) and obtains therefrom a trigger for measurement, which facilitates a later local assignment of the measurement.

The early processing of the data in the field, near the measurement location, may be advantageous in this case. This reduces the load on the IT system since high data rates occur on account of the high production speed and would block even modern high-speed networks. As early as directly after the measurement, therefore, the data set is precompressed and a measure of the lateral distribution of the materials along the considered measurement line, i.e. a vector of the inhomogeneity, is assigned to the web position. This information is already two to three orders of magnitude smaller than the raw data of the actual measurement (one HSI frame: 640×224 pixels vs. an evaluation result: 640×1 vector or only a scalar indicator).

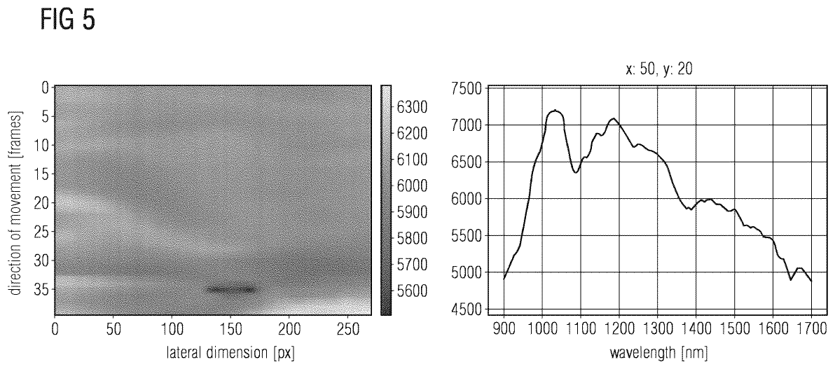

FIG. 5 shows a measurement point of one exemplary embodiment. The image on the left represents an excerpt from a hyperspectral image of an electrode web. Inhomogeneities are represented here by different gray shades. The diagram on the right shows the spectral evaluation of the pixel with the coordinate 15/20. For each spatial coordinate x, y of the image on the left there exists a spectrum which describes the chemical properties of this image point (=pixel).

The measured spectra can be analyzed in at least two ways:
A) supervised machine learning: calibration of a model which either maps the spectra onto a target value (e.g. content of graphite) or classifies them (e.g. OK, not OK). There exist for this purpose methods such as partial least squares, principal component regression, Gaussian processes, or neural networks.
B) unsupervised machine learning: recognition of anomalies, e.g. local inhomogeneities in the coating of the electrode web (e.g., the variance of the slurry deposition may increase at the outer edges, layer thickness changes). Statistical features can be calculated for this purpose, such as e.g. the local variance or entropy. Alternatively, residual models (e.g. low-rank PCA approximation, variational auto-encoder neural networks) can be created.

In both cases, the analyses can be supplemented by preprocessing steps, for example by freeing the coating foreground from the substrate foil, filtering out sensor information according to its degree of explained variance, or increasing the contrast.

Although the teachings herein have been more specifically illustrated and described in detail by means of the exemplary embodiments, the scope of the disclosure is not restricted by the examples disclosed, and other variations can be derived therefrom by a person skilled in the art, without departing from the scope of protection.

### LIST OF REFERENCE SIGNS

1 carrier foil
2 slurry
3 application tool
4 coating direction
5 plan view
6 intermittent coating
7 store for slurry 2
8 wet thickness measurement
9 dryer
10 vapors
11 air nozzle
12 extractor
13 cooling device
14 cooling rollers
15 calender
16 roller pair
17 traction mechanism
18 draw-in feed
19 storage roll
20 cleaning mechanism
21 mother coil
22 line scan camera
23 evaluation and computing unit
23.1 storage unit
24 manufacturing control system
25 deflection roll
26 electrode web
27 spectroscopy unit
28 engraving unit

What is claimed is:

1. An apparatus for hyperspectral imaging of electrode web during electrode manufacturing for battery cells, the apparatus comprising:
a hyperspectral spectroscopy unit with a line scan camera for imaging, the spectroscopy unit configured:
to capture hyperspectral images of the forward-moving electrode web at a predefined location of the electrode manufacturing,
to ascertain inhomogeneities of the electrode web from the images, wherein an inhomogeneity is a deviation of the chemical composition of the layers or of the particle size distribution from predefined target variables, and
to ascertain and save a local position of the inhomogeneities in the longitudinal direction of the electrode web; and
a deflection roll over which the electrode web is guided;
wherein the line scan camera captures the images at the position of the contact surface between the deflection roll and the electrode web.

2. The apparatus as claimed in claim 1, wherein saving the local position of the inhomogeneity includes marking the electrode web.

3. The apparatus as claimed in claim 2, further comprising an engraving unit to implement the marking with an engraving at a longitudinal edge of the electrode web.

4. The apparatus as claimed in claim 1, further comprising a storage unit to store spectral characteristics of the inhomogeneity as spatial encoding along the electrode web so the position of the inhomogeneity is able to be found on the basis of the spectral characteristics.

5. The apparatus as claimed in claim 1, further comprising
a manufacturing control system connected to the spectroscopy unit and configured to trigger the spectroscopy unit for measurement.

6. The apparatus as claimed in claim 1, further comprising
an evaluation and computing unit at the location of the spectroscopy unit to compress data of the spectroscopic imaging in a vector and to assign same to the local position.

7. The apparatus as claimed in claim 1, wherein the line scan camera comprises an SWIR line scan camera.

8. The apparatus as claimed in claim 1, wherein the spectroscopy unit comprises an AI engine to ascertain the inhomogeneities in a computer-aided manner.

9. The apparatus as claimed in claim 8, wherein the AI engine is trained to ascertain the inhomogeneities from the spectra using deep learning methods.

10. A method for ascertaining inhomogeneities by hyperspectral imaging of electrode webs during electrode manufacturing for battery cells, the method comprising:
capturing hyperspectral images of the forward-moving electrode web at a predefined location of the electrode manufacturing;
ascertaining inhomogeneities of the electrode web from the spectra of the images, wherein an inhomogeneity is a deviation of the chemical composition of the layers or of the particle size distribution from predefined target variables; and
ascertaining and saving the local position of the inhomogeneities in the longitudinal direction of the electrode web;
wherein the line scan camera captures the images at the position of the contact surface between a deflection roll over which the electrode web is guided, and the electrode web.

11. The method as claimed in claim 10, wherein saving the local position of the inhomogeneity includes marking on the electrode web.

12. The method as claimed in claim 10, further comprising saving the spectral characteristics of the inhomogeneity as spatial encoding along the electrode web in such a way that the position of the inhomogeneity is able to be found on the basis of the spectral characteristics.

13. The method as claimed in claim 10, wherein ascertaining the inhomogeneities includes using a computer with an AI engine.
